(19) United States
(12) Patent Application Publication
(10) Pub. No.: US 2025/0385769 A1
(43) Pub. Date: Dec. 18, 2025

(54) DEMODULATION REFERENCE SIGNAL (DMRS) HOPPING FOR A PHYSICAL DOWNLINK SHARED CHANNEL OR A PHYSICAL UPLINK SHARED CHANNEL

(71) Applicant: QUALCOMM Incorporated, San Diego, CA (US)

(72) Inventors: Chih-Hao LIU, San Diego, CA (US); Jing JIANG, San Diego, CA (US); Jing SUN, San Diego, CA (US)

(21) Appl. No.: 18/745,697

(22) Filed: Jun. 17, 2024

(51) Int. Cl. H04L 5/00

(52) U.S. Cl. CPC H04L 5/0051

(57) ABSTRACT

A method for wireless communication at a user equipment (UE) includes receiving, from a network node, a first downlink control information (DCI) message that includes a start and length indicator value (SLIV) indicating an allocation of physical downlink shared channel (PDSCH) resources or physical uplink shared channel (PUSCH) resources. The method also includes receiving, from the network node, a first message indicating a first demodulation reference signal (DMRS) hopping pattern for a group of DMRS symbols associated with the SLIV. The method further includes receiving, from the network node, the group of DMRS symbols or transmitting, to the network node, the group of DMRS symbols. Each DMRS symbol of the group of DMRS symbols includes one or more of DMRS tones, and each DMRS tone of the one or more of DMRS tones may be associated with a carrier frequency in accordance with the first DMRS hopping pattern.

### INTRODUCTION

The present disclosure relates generally to wireless communications, and more specifically to transmitting or receiving demodulation reference signals (DMRSs). Wireless communication systems are widely deployed to provide various telecommunications services such as telephony, video, data, messaging, and broadcasts. Typical wireless communication systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In some aspects of the present disclosure, a method for wireless communication at a user equipment (UE) includes receiving, from a network node, a first downlink control information (DCI) message that includes a start and length indicator value (SLIV) indicating an allocation of physical downlink shared channel (PDSCH) resources. The method also includes receiving, from the network node, a first message indicating a first demodulation reference signal (DMRS) hopping pattern for a group of DMRS symbols associated with the SLIV. The method further includes receiving, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus. The apparatus includes means for receiving, from a network node, a first DCI message that includes a SLIV indicating an allocation of PDSCH resources. The apparatus further includes means for receiving, from the network node, a first message indicating a first DMRS hopping pattern for a group of DMRS symbols associated with the SLIV. The apparatus also includes means for receiving, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

In other aspects of the present disclosure, a non-transitory computer-readable medium with program code recorded thereon is disclosed. The program code is executed by one or more processors and includes program code to receive, from a network node, a first DCI message that includes a SLIV indicating an allocation of PDSCH resources. The program code further includes program code to receive, from the network node, a first message indicating a first DMRS hopping pattern for a group of DMRS symbols associated with the SLIV. The program code also includes program code to receive, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus for wireless communication at a UE. The apparatus includes one or more processors, and one or more memories coupled with the one or more processors and storing processor-executable code that, when executed by the one or more processors, is configured to cause the apparatus to receive, from a network node, a first DCI message that includes a SLIV that indicates an allocation of PDSCH resources. Execution of the processor-executable code further causes the apparatus to receive, from the network node, a first message that indicates a first DMRS hopping pattern for a group of DMRS symbols associated with the SLIV. Execution of the processor-executable code also causes the apparatus to receive, from the network node, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

Other aspects of the present disclosure are directed to an apparatus for wireless communication at a UE. The apparatus includes one or more processors, and one or more memories coupled with the one or more processors. The one or more processors are configured to cause the UE to receive, from a network node, a first DCI message that includes a SLIV that indicates an allocation of PDSCH resources. The one or more processors are also configured to cause the UE to receive, from the network node, a first message that indicates a first DMRS hopping pattern for a group of DMRS symbols associated with the SLIV. The one or more processors are further configured to cause the UE to receive, from the network node, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

In some aspects of the present disclosure, a method for wireless communication at a UE includes receiving, from a network node, a first DCI message that includes a SLIV indicating an allocation of physical uplink shared channel (PUSCH) resources. The method also includes receiving, from the network node, a first message indicating a first DMRS hopping pattern for a group of DMRS symbols associated with the SLIV. The method further includes transmitting, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus. The apparatus includes means for receiving, from a network node, a first DCI message that includes a SLIV indicating an allocation of PUSCH resources. The apparatus further includes means for receiving, from the network node, a first message indicating a first DMRS hopping pattern for a group of DMRS symbols associated with the SLIV. The apparatus also includes means for transmitting, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

In other aspects of the present disclosure, a non-transitory computer-readable medium with program code recorded thereon is disclosed. The program code is executed by one or more processors and includes program code to receive, from a network node, a first DCI message that includes a SLIV indicating an allocation of PUSCH resources. The program code further includes program code to receive, from the network node, a first message indicating a first DMRS hopping pattern for a group of DMRS symbols associated with the SLIV. The program code also includes program code to transmit, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus for wireless communication at a UE. The apparatus includes one or more processors, and one or more memories coupled with the one or more processors. The one or more processors are configured to cause the UE to receive, from a network node, a first DCI message that includes a SLIV that indicates an allocation of PUSCH resources. The one or more processors are also configured to cause the UE to receive, from the network node, a first message that indicates a first DMRS hopping pattern for a group of DMRS symbols associated with the SLIV. The one or more processors are further configured to cause the UE to transmit, to the network node, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

In some aspects of the present disclosure, a method for wireless communication at a network node includes transmitting a first DCI message that includes a SLIV indicating an allocation of PDSCH resources. The method further includes transmitting a first message indicating a first DMRS hopping pattern for a group of DMRS symbols associated with the SLIV. The method also includes transmitting the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus. The apparatus includes means for transmitting a first DCI message that includes a SLIV indicating an allocation of PDSCH resources. The apparatus further includes means for transmitting a first message indicating a first DMRS hopping pattern for a group of DMRS symbols associated with the SLIV. The apparatus also includes means for transmitting the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

In other aspects of the present disclosure, a non-transitory computer-readable medium with program code recorded thereon is disclosed. The program code is executed by one or more processors and includes program code to transmit a first DCI message that includes a SLIV indicating an allocation of PDSCH resources. The program code further includes program code to transmit a first message indicating a first DMRS hopping pattern for a group of DMRS symbols associated with the SLIV. The program code also includes program code to transmit the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus for wireless communication at a network node. The apparatus includes one or more processors, and one or more memories coupled with the one or more processors and storing processor-executable code that, when executed by the one or more processors, is configured to cause the apparatus to transmit a first DCI message that includes a SLIV that indicates an allocation of PDSCH resources. Execution of the processor-executable code further causes the apparatus to transmit a first message that indicates a first DMRS hopping pattern for a group of DMRS symbols associated with the SLIV. Execution of the processor-executable code also causes the apparatus to transmit the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

Other aspects of the present disclosure are directed to an apparatus for wireless communication at a network node. The apparatus includes one or more processors, and one or more memories coupled with the one or more processors. The one or more processors are configured to cause the network node to transmit a first DCI message that includes a SLIV that indicates an allocation of PDSCH resources. The one or more processors are also configured to cause the network node to transmit a first message that indicates a first DMRS hopping pattern for a group of DMRS symbols associated with the SLIV. The one or more processors are further configured to cause the network node to transmit the group of DMRS symbols, each DMRS symbol of the group of DMRS symbols include one or more of DMRS tones, each DMRS tone of the one or more of DMRS tones associated with a carrier frequency in accordance with the first DMRS hopping pattern.

In some aspects of the present disclosure, a method for wireless communication at a network node includes transmitting a first DCI message that includes a SLIV indicating an allocation of PUSCH resources. The method further includes transmitting a first message indicating a first DMRS hopping pattern for a group of DMRS symbols associated with the SLIV. The method also includes receiving, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus. The apparatus includes means for transmitting a first DCI message that includes a SLIV indicating an allocation of PUSCH resources. The apparatus further includes means for transmitting a first message indicating a first DMRS hopping pattern for a group of DMRS symbols associated with the SLIV. The apparatus also includes means for receiving, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

In other aspects of the present disclosure, a non-transitory computer-readable medium with program code recorded thereon is disclosed. The program code is executed by one or more processors and includes program code to transmit a first DCI message that includes a SLIV indicating an allocation of PUSCH resources. The program code further includes program code to transmit a first message indicating a first DMRS hopping pattern for a group of DMRS symbols associated with the SLIV. The program code also includes program code to receive, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Other aspects of the present disclosure are directed to an apparatus for wireless communication at a network node. The apparatus includes one or more processors, and one or more memories coupled with the one or more processors. The one or more processors are configured to cause the network node to transmit a first DCI message that includes a SLIV that indicates an allocation of PDSCH resources. The one or more processors are also configured to cause the network node to transmit a first message that indicates a first DMRS hopping pattern for a group of DMRS symbols associated with the SLIV. The one or more processors are further configured to cause the network node to receive, from a UE, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network and an access network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4A, 4B, 4C, and 4D are diagrams illustrating examples of a radio frame, downlink (DL) channels within a subframe, a second frame, and uplink (UL) channels within a subframe, respectively, in accordance with various aspects of the present disclosure.

FIG. 5A is a block diagram illustrating an example of a demodulation reference signal (DMRS) hopping pattern, in accordance with various aspects of the present disclosure.

FIG. 5B is a block diagram illustrating an example of a DMRS hopping pattern, in accordance with various aspects of the present disclosure.

FIG. 6 is a block diagram illustrating an example of a per transmission time interval (TTI) hopping pattern, in accordance with various aspects of the present disclosure.

FIG. 7 is a block diagram illustrating an example of defining a hopping pattern across different TTIs, in accordance with various aspects of the present disclosure.

FIG. 8 is a timing diagram illustrating an example of configuring a DMRS hopping pattern, in accordance with various aspects of the present disclosure.

FIG. 9 is a flow diagram illustrating an example process performed, for example, by a UE, in accordance with various aspects of the present disclosure.

FIG. 10 is a flow diagram illustrating an example process performed, for example, by a UE, in accordance with various aspects of the present disclosure.

FIG. 11 is a flow diagram illustrating an example process performed, for example, by a network node, in accordance with various aspects of the present disclosure.

FIG. 12 is a flow diagram illustrating an example process performed, for example, by a network node, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, a user equipment (UE) may receive downlink signaling, such as downlink control information (DCI), that includes an uplink grant for communication. The uplink grant may include a time domain resource assignment that includes an index value configured according to radio resource control (RRC) signaling. The index value may be a start and length indicator value (SLIV) that includes a starting symbol and a transmission duration for transmitting uplink data via a physical uplink shared channel (PUSCH). The SLIV is not limited to uplink transmissions. Downlink transmissions via a physical downlink shared channel (PDSCH) may also be transmitted in accordance with a SLIV. In such wireless communication systems, PUSCH resources or PDSCH resources may align with respective slot boundaries.

In some wireless communication systems, one or more demodulation reference signals (DMRSs) may be allocated per slot. As one example, a first SLIV may be associated with a first DCI grant and a second SLIV may be associated with a second DCI. In such examples, resources allocated by each SLIV (e.g., the first SLIV and the second SLIV) are limited to respective slots and do not cross a slot boundary. In some examples, different SLIVs share a same DMRS precoder. In some such cases, when decoding the second SLIV, the channel estimation may be based on the DMRS of the current SLIV and also the DMRS of the previous SLIV. In other such cases, when decoding a first slot (e.g., slot N), the UE may estimate the channel after receiving one or more DMRSs in a subsequent slot (e.g., slot N+1).

In some wireless communication systems, such as sixth generation (6G) and beyond, a SLIV may allocate PxSCH resources (for example, PUSCH resources or PDSCH resources) to a group of slots irrespective of slot boundaries. The SLIV that allocates PxSCH resources to the group of slots, irrespective of slot boundaries, may be referred to as a long SLIV. This resource allocation is in contrast to a SLIV that limits resources to a single slot. For example, the long SLIV may allocate PDSCH resources or PUSCH resources to multiple slots, irrespective of slot boundaries. In such cases, because the PDSCH resources or PUSCH resources may be allocated across multiple slots, multiple DMRSs within the long SLIV, may be used for joint channel estimation. The use of the long SLIV reduces DMRS time domain overhead by mitigating the need for a consistent DMRS pattern on a per-slot basis. For example, some wireless communication systems specify a DMRS pattern that allocates a specific number of DMRS symbols per slot. In contrast, for the long SLIV, a network node may schedule DMRS across multiple slots, and the DMRS symbols may not be allocated in accordance with a specific DMRS pattern. A DMRS symbol is an example of a symbol that includes one or more DMRS tones.

Increasing the sparsity of DMRS tones (e.g., pilot tones) in the frequency domain may lead to an aliasing effect, particularly when a channel has a long delay spread. The aliasing effect refers to a distortion or misrepresentation of the channel that occurs when the channel is sampled at a rate that is insufficient to accurately sample the channel's frequency components. The delay spread refers to the variation in arrival times of different components of a signal due to multipath propagation. A longer delay spread implies that the signal takes more time to travel through the channel and may experience more distortion. For a long SLIV, where resources (e.g., PUSCH resources or PDSCH resources) are allocated across multiple slots, additional measures may be specified to obtain accurate channel estimates. In some examples, multiple DMRS symbols may be allocated per slot to address Doppler shift. Each DMRS symbol may include one or more DMRS tones. The Doppler shift refers to the change in frequency observed when there is relative motion between the transmitter and receiver. By spreading multiple DMRS symbols across the transmission, the impact of the Doppler shift may be mitigated.

To accommodate multiple DMRS symbols in each slot of one or more slots associated with a SLIV or a long SLIV, a DMRS hopping pattern may be specified. The DMRS hopping pattern allocates an offset for DMRS tones (e.g., pilot tones) across a frequency domain over a period of time. DMRS tones are examples of specific subcarriers within a frequency domain of a signal. DMRS tones provide known reference points that assist the receiver in estimating channel characteristics. The offset specifies a shift in resource elements allocated to respective DMRS tones of one DMRS symbol in comparison to resource elements allocated to respective DMRS tones of another DMRS symbol of the multiple DMRS symbols. In some examples, the DMRS hopping pattern may be associated with the long SLIV. Still, various aspects of the present disclosure are not limited to the long SLIV and may be used for a SLIV.

Various aspects of the present disclosure are directed to a DMRS hopping pattern for a group of DMRS symbols (e.g., two or more DMRS symbols) within each slot of one or more slots. In some examples, a network node may transmit a downlink control information (DCI) message that includes a start and length indicator value (SLIV) indicating an allocation of PDSCH resources or PUSCH resources. In some examples, the SLIV is a long SLIV, such that the PDSCH resources or PUSCH resources are allocated to a group of slots, irrespective of slot boundaries of the group of slots. The network node may also transmit a message indicating a DMRS hopping pattern for the group of DMRS symbols associated with the SLIV. Additionally, the network node may transmit the group of DMRS symbols or the UE may transmit the group of DMRS symbols based on whether the SLIV allocated PDSCH resources or PUSCH resources. Each DMRS symbol of the group of DMRS symbols includes one or more DMRS tones associated with respective resource elements (REs) in the DMRS symbol in accordance with the DMRS hopping pattern. In some examples, respective DMRS tones of sequential pairs of DMRS symbols, of the group of DMRS symbols, may be offset with respect to carrier frequency in accordance with the DMRS hopping pattern. In some examples, the DMRS hopping pattern may be periodic, with a periodicity of a subset of DMRS symbols of the group of DMRS symbols. For example, the DMRS hopping pattern may repeat every N DMRS symbols. Additionally, or alternatively, the DMRS hopping pattern may be defined per transmission time interval (TTI) (e.g., slot) or across different TTIs.

Particular aspects of the subject matter described in this disclosure can be implemented to realize one or more of the following potential advantages. In some examples, the described techniques of defining a DMRS hopping pattern may offset locations of DMRS tones over time, thereby mitigating the potential for aliasing due to sparse DMRS patterns. Additionally, in some examples, the DMRS hopping pattern distributes DMRS tones more evenly across the frequency spectrum, thereby improving the accuracy of channel estimation.

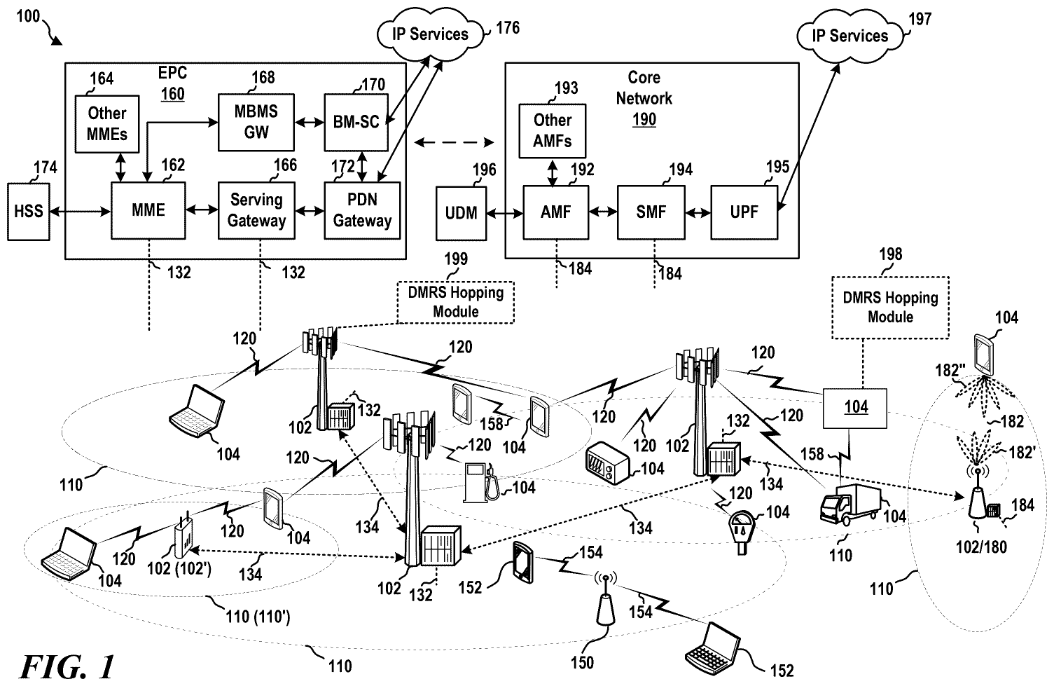

FIG. 1 is a diagram illustrating an example of a wireless communications system and an access network 100. The wireless communications system (also referred to as a wireless wide area network (WWAN)) includes base stations 102, UEs 104, an evolved packet core (EPC) 160, and another core network 190 (e.g., a 5G core (5GC)). The base stations 102 may include macrocells (high power cellular base station) and/or small cells 102′ (low power cellular base station). The macrocells include base stations. The small cells 102′ include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (e.g., SI interface). The base stations 102 configured for 5G NR (collectively referred to as next generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communications coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include home evolved Node Bs (eNBs) (HeNBs), which may provide service to a restricted group known as a closed subscriber group (CSG). The communications links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communications links 120 may use multiple-input and multiple-output (MIMO) antenna technology, including spatial multiplexing, beamforming, and/or transmit diversity. The communications links may be through one or more carriers. The base stations 102/UEs 104 may use spectrum up to Y MHz (e.g., 5, 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communications link 158. The D2D communications link 158 may use the DL/UL WWAN spectrum. The D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communications may be through a variety of wireless D2D communications systems, such as FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communications links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave. Communications using the mmWave/near mmWave radio frequency band (e.g., 3 GHz-300 GHz) has extremely high path loss and a short range. The mmWave base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN gateway 172. The PDN gateway 172 provides UE IP address allocation as well as other functions. The PDN gateway 172 and the BM-SC 170 are connected to the IP services 176. The IP services 176 may include the Internet, an intranet, an IP multimedia subsystem (IMS), a PS streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) area broadcasting a particular service, and may be responsible for session management (start/stop) and for collecting evolved MBMS (eMBMS) related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality of service (QOS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as Internet of Things (IoT) devices (e.g., a parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

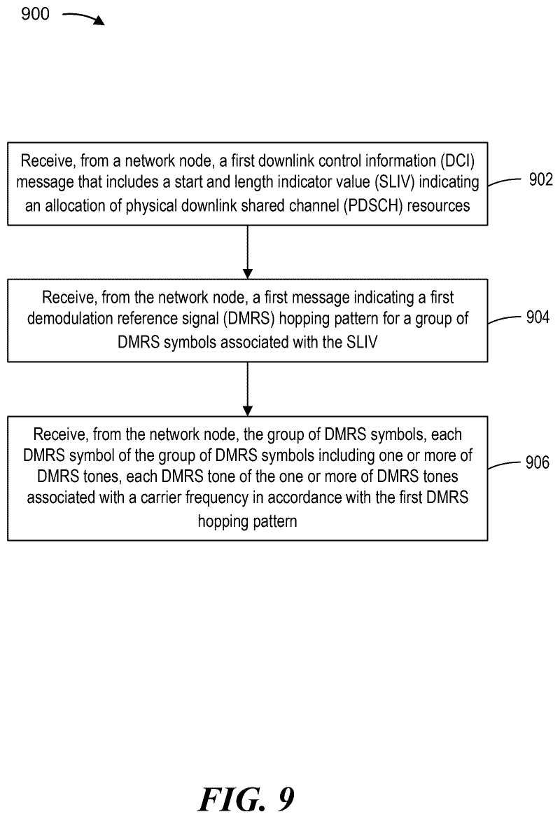

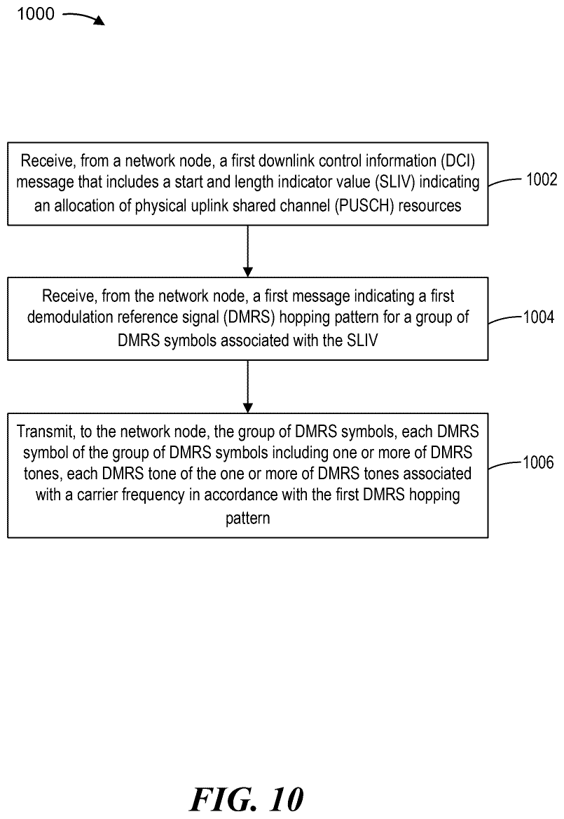

Referring again to FIG. 1, in certain aspects, a receiving device, such as the UE 104, may receive sensing information from one or more other UEs 104. The UE 104 that received the sensing information may also obtain sensing information from its own measurements. The UE 104 may include a DMRS hopping module 198. For brevity, only one UE 104 is shown as including the DMRS hopping module 198. The DMRS hopping module 140 may perform one or more operations, such as one or more operations of a process 900 and/or 1000 described with reference to FIGS. 9 and 10, respectively.

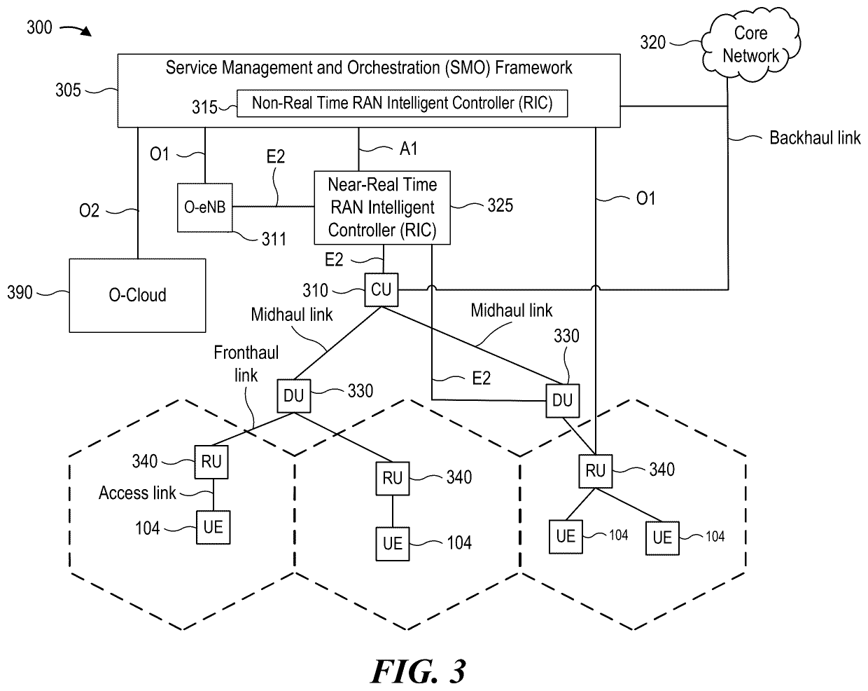

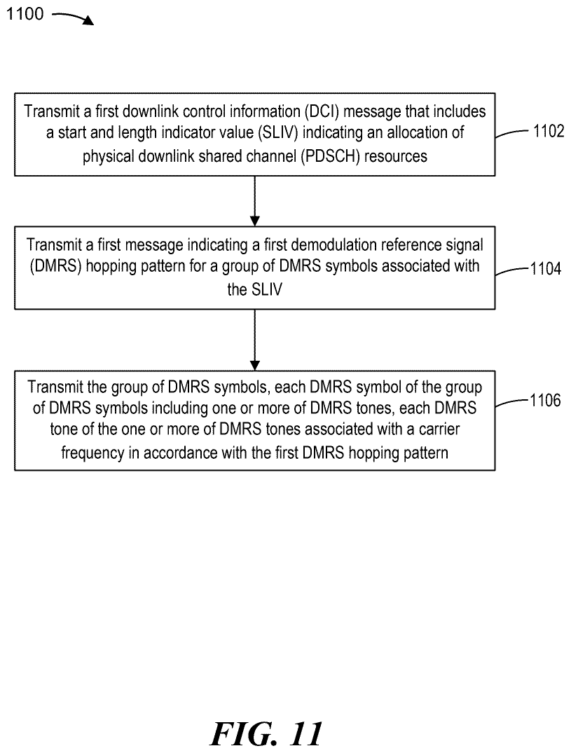

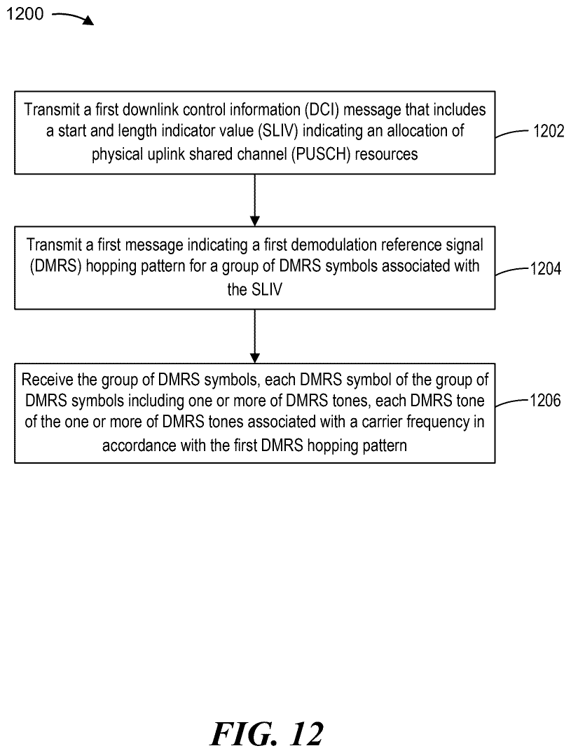

The core network 190, one or more of the base stations 102, and/or or any other network device (e.g., as seen in FIG. 3) may include a DMRS hopping module 199 that may perform one or more operations, such as one or more operations of a process 1100 and/or 1200 described with reference to FIGS. 11 and 12, respectively.

In some aspects, the network 100 may operate over a shared channel, which may include shared frequency bands and/or unlicensed frequency bands. For example, the network 100 may be an NR-U network operating over an unlicensed frequency band. In such an aspect, the BSs 102 and the UEs 104 may be operated by multiple network operating entities. To avoid collisions, the BSs 102 and the UEs 104 may employ a listen-before-talk (LBT) procedure to monitor for transmission opportunities (TXOPs) in the shared channel. A TXOP may also be referred to as COT. For example, a transmitting node (e.g., a BS 102 or a UE 104) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT4 LBT may be referred to as a Type1 LBT, where the LBT is performed independently on the carrier(s) on which a transmission is occurring or going to occur. Under Type2 LBT, one carrier can be selected to have a CAT4 LBT performed, and a single interval LBT (Type2 LBT) can be performed on other carriers, which may be performed before a scheduled start time that is indicated by the UL grants. As an example, a transmitting node may determine a channel measurement in a time interval and determine whether the channel is available or not based on a comparison of the channel measurement against an ED threshold.

Although the following description may be focused on 5G NR, it may be applicable to other similar areas, such as LTE, LTE-A, CDMA, GSM, and other wireless technologies, such as 6G and beyond.

As indicated above, FIG. 1 is provided merely as an example. Other examples may differ from what is described with regard to FIG. 1.

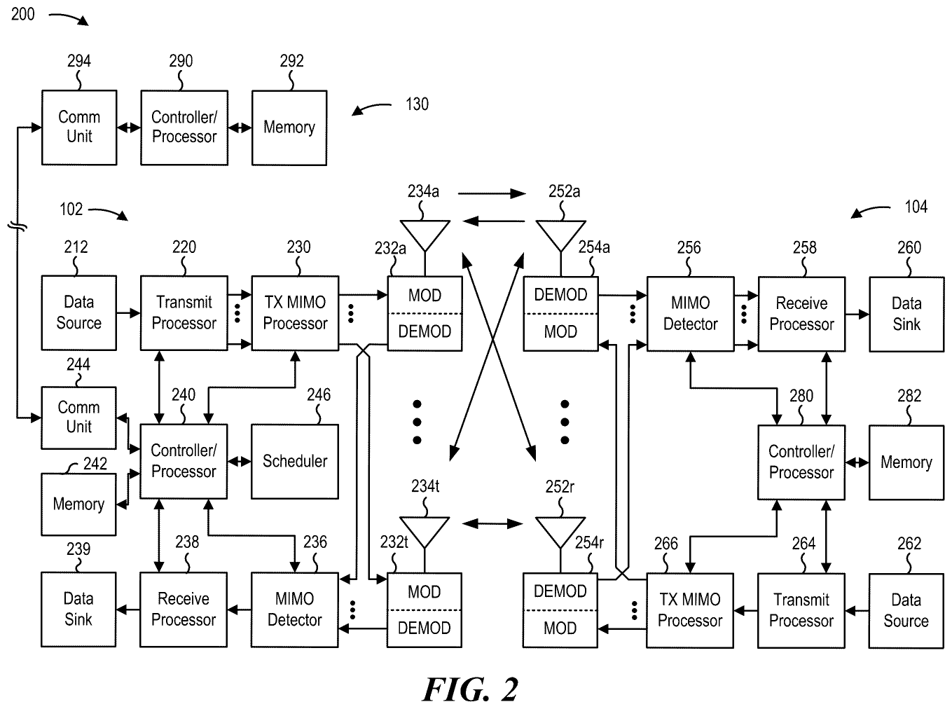

FIG. 2 shows a block diagram of a design 200 of the base station 102 and UE 104, which may be one of the base stations and one of the UEs in FIG. 1. The base station 102 may be equipped with T antennas 234a through 234t, and UE 104 may be equipped with R antennas 252a through 252r, where in general T≥1 and R≥1.

At the base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 104, antennas 252a through 252r may receive the downlink signals from the base station 102 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 104 may be included in a housing.

On the uplink, at the UE 104, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 102. At the base station 102, the uplink signals from the UE 104 and other UEs may be received by the antennas 234, processed by the demodulators 254, detected by a MIMO detector 236 if applicable, and further processed by a receive processor 238 to obtain decoded data and control information sent by the UE 104. The receive processor 238 may provide the decoded data to a data sink 239 and the decoded control information to a controller/processor 240. The base station 102 may include communications unit 244 and communicate to the core network 130 via the communications unit 244. The core network 130 may include a communications unit 294, a controller/processor 290, and a memory 292.

The controller/processor 240 of the base station 102, the controller/processor 280 of the UE 104, and/or any other component(s) of FIG. 2 may perform one or more techniques associated with configuring DMRS hopping pattern for a group of DMRS symbols associated with a SLIV allocation, as described in more detail elsewhere. For example, the controller/processor 240 of the base station 102, the controller/processor 280 of the UE 104, and/or any other component(s) of FIG. 2 may perform or direct operations of, for example, the processes of FIGS. 9, 10, 11, and 12 and/or other processes as described. Memories 242 and 282 may store data and program codes for the base station 102 and UE 104, respectively. A scheduler 246 may schedule UEs for data transmission on the downlink and/or uplink.

In some aspects, the UE 104 may include means for receiving, from a network node, a first DCI message that includes a SLIV indicating an allocation of PDSCH resources; means for receiving, from the network node, a first message indicating a first DMRS hopping pattern for a group of DMRS symbols associated with the SLIV; and means for receiving, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

The means for the UE to perform operations described herein may include, for example, one or more of the DMRS hopping module 198, antenna 252, modem 254, MIMO detector 256, receive processor 258, transmit processor 264, TX MIMO processor 266, controller/processor 280, or memory 282.

Additionally, or alternatively, the network node 102 may include means for receiving, means for transmitting a first DCI message that includes a SLIV indicating an allocation of PDSCH resources; means for transmitting a first message indicating a first DMRS hopping pattern for a group of DMRS symbols associated with the SLIV; and means for transmitting the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

The means for the network node 102 to perform operations described herein may include, for example, one or more of a DMRS hopping module 199, transmit processor 220, TX MIMO processor 230, modem 232, antenna 234, MIMO detector 236, receive processor 238, controller/processor 240, memory 242, or scheduler 246.

In some examples, means for transmitting, outputting, or sending (or means for outputting for transmission) may include one or more antennas, a modulator, a transmit MIMO processor, a transmit processor, or a combination thereof, of the UE 104 or network node 102 described above in connection with FIG. 2.

In some examples, means for receiving (or means for obtaining) may include one or more antennas, a demodulator, a MIMO detector, a receive processor, or a combination thereof, of the UE 104 or network node 102 described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

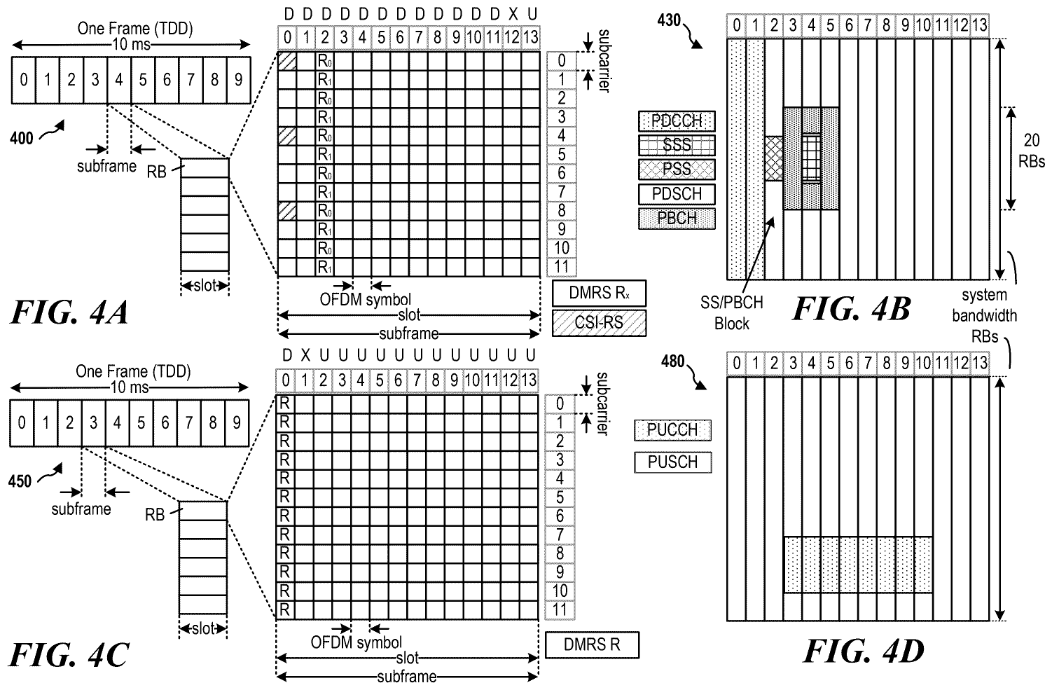

FIG. 4A is a diagram 400 illustrating an example of a first subframe within frame structure, such as a 5G NR frame structure. FIG. 4B is a diagram 430 illustrating an example of DL channels within subframe, such as a 5G NR subframe. FIG. 4C is a diagram 450 illustrating an example of a second subframe within a frame structure, such as a 5G NR frame structure. FIG. 4D is a diagram 480 illustrating an example of UL channels within a subframe, such as a 5G NR subframe. The frame structure may be frequency division duplex (FDD) in which for a particular set of subcarriers (carrier system bandwidth), subframes within the set of subcarriers are dedicated for either DL or UL, or may be time division duplex (TDD) in which for a particular set of subcarriers (carrier system bandwidth), subframes within the set of subcarriers are dedicated for both DL and UL. In the examples provided by FIGS. 4A, 4C, the frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a TDD frame structure.

Other wireless communications technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-S-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A-4D provide an example of slot configuration 0 with 14 symbols per slot and numerology μ=0 with 1 slot per subframe. The subcarrier spacing is 15 kHz and symbol duration is approximately 66.7 μs.

A resource grid may represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment/negative acknowledgement (ACK/NACK) feedback. The PUSCH carries data, and may additionally be used to carry a buffer status report (BSR), a power headroom report (PHR), and/or UCI.

As discussed, in some wireless communication systems, such as sixth generation (6G) and beyond, a long SLIV may allocate PxSCH resources (for example, PUSCH resources or PDSCH resources) to a group of slots. In such systems, the PxSCH resources are allocated irrespective of slot boundaries. In such cases, because the PxSCH resources may be allocated across multiple slots, multiple DMRSs, within the SLIV (e.g., long SLIV), may be used for joint channel estimation. The use of the long SLIV reduces DMRS time domain overhead by mitigating the need for a consistent DMRS pattern on a per-slot basis. For example, some conventional wireless communication systems require a specific number of DMRS symbols per slot. In contrast, for the long SLIV, a network node may schedule DMRS across multiple slots, and the DMRSs may not be allocated in accordance with a specific pattern. Still, in some cases, the DMRSs may be evenly spaced to accommodate for Doppler shift.

In some cases, sparser frequency domain patterns may be specified to reduce DMRS resource allocation in the frequency domain. In the context of 5G NR, DMRS configurations specify different patterns for organizing DMRS tones within the frequency domain. For example, DMRS configuration type 1 follows a comb-2 structure, where DMRS tones are spaced every two resource elements in the frequency domain. As another example, configuration type 2 allocates DMRS tones every six REs, occupying two out of every six REs in a symbol. For 6G systems and beyond with long SLIV allocations, DMRS sparsity may increase. For example, comb-3 or com-4 configurations may be considered. Alternatively, 6G systems may continue using DMRS configuration type-2.

Increasing the sparsity of DMRS tones (e.g., pilot tones) in the frequency domain may lead to an aliasing effect, particularly when a channel has a long delay spread. Delay spread refers to the variation in arrival times of different components of a signal due to multipath propagation. A longer delay spread implies that the signal takes more time to travel through the channel and may experience more distortion.

For example, in channel estimation using DMRS type-2, DMRS tones are inserted at intervals where approximately four or five resource elements (e.g., subcarriers) are interpolated among the DMRS tones within a symbol. This interpolation ensures that there are enough DMRSs for accurate channel estimation across a frequency spectrum. However, for a long SLIV, where resources are allocated across multiple slots, additional measures may be specified to obtain accurate channel estimates. In some examples, multiple DMRS symbols may be allocated per slot to address the Doppler shift. The Doppler shift refers to the change in frequency observed when there is relative motion between the transmitter and receiver. By having multiple DMRS symbols spread across the transmission, the impact of the Doppler shift may be mitigated. Additionally, for each slot, DMRS tones in a second DMRS symbol may be associated with carrier frequencies (e.g., subcarriers) that are different from carrier frequencies associated with DMRS tones in a first DMRS symbol. Associating the DMRS tones with different carrier frequencies may improve channel estimation by providing a broader sampling of the channel characteristic, thereby enabling a more accurate channel estimation even in challenging propagation environments.

To accommodate multiple DMRS symbols in one or more slots associated with a SLIV or a long SLIV, a DMRS hopping pattern may be specified. DMRS hopping may specify an offset for DMRS tones (e.g., pilot tones) across a frequency domain over a period of time, such that DMRS tones in different symbols may be associated with different carrier frequencies. The different symbols may be within one or more slots. Various aspects of the present disclosure are directed to a DMRS hopping pattern for a group of DMRS symbols within one or more slots. In some examples, the DMRS hopping pattern may be associated with a long SLIV. Still, various aspects of the present disclosure are not limited to the long SLIV and may be used for a SLIV.

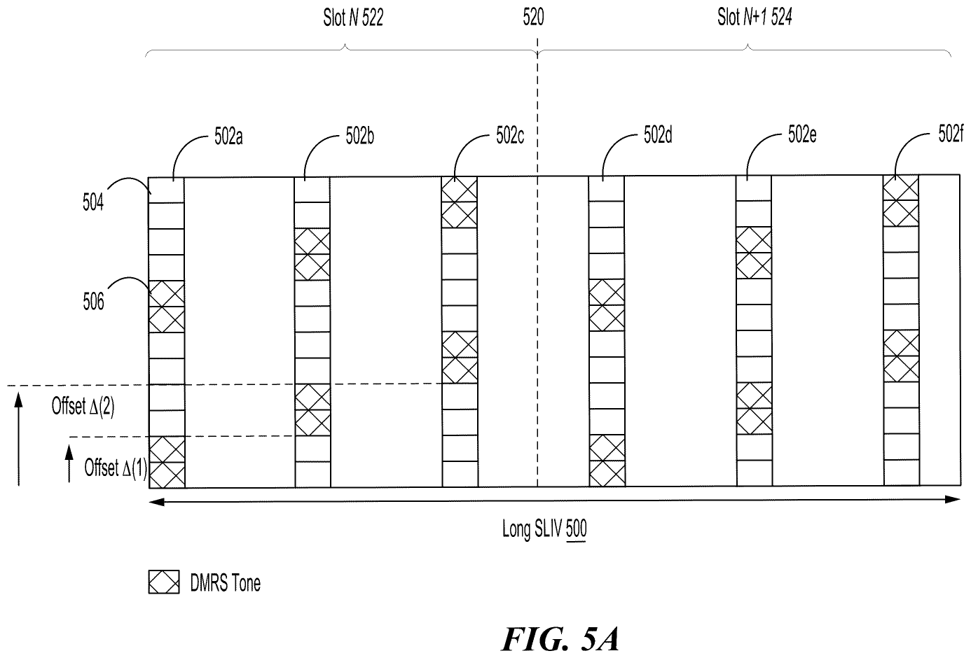

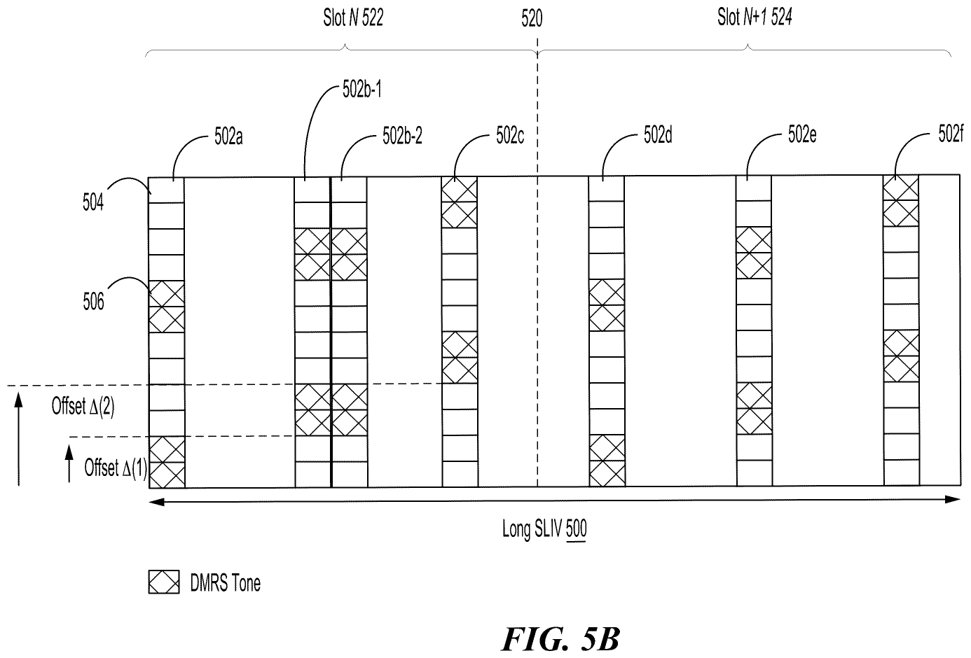

As discussed, in some examples, a network node may indicate a DMRS hopping pattern for a group of DMRS symbols associated with a SLIV. FIG. 5A is a block diagram illustrating an example of a DMRS hopping pattern, in accordance with various aspects of the present disclosure. In the example of FIG. 5A, a long SLIV 500 may allocate PDSCH resources to a group of slots, irrespective of slot boundaries (the slot boundaries are not shown in the example of FIG. 5A). As an example, the long SLIV 500 allocates PDSCH resources to a first slot 522 (slot N) and a second slot 524 (slot N+1) irrespective of the slot boundary 520. In other examples, the long SLIV 500 allocates PUSCH resources to the first slot 522 and the second slot 524 (slot N+1) irrespective of the slot boundary 520.

Additionally, as shown in the example of FIG. 5A, a group of DMRS symbols 502a, 502b, 502c, 502d, 502e, and 502f may be allocated (e.g., scheduled) with the long SLIV 500. Each DMRS symbol 502a, 502b, 502c, 502d, 502e, and 502f includes a group of resource elements 504. For ease of explanation only one resource element 504 is labeled in the example of FIG. 5A. Additionally, DMRS tones 506 (shown as cross-hatching) may be allocated to a subset of the group of resource elements 504 in each DMRS symbol 502a, 502b, 502c, 502d, 502e, and 502f. For case of explanation, only one DMRS tone 506 is labeled in the example of FIG. 5A. In the example of FIG. 5A, a first DMRS symbol 502a and a second DMRS symbols 502b may be examples of sequential pairs of DMRS symbols. These sequential pairs of DMRS symbols are sequential in time, with respect to the other DMRS symbols of the group of DMRS symbols 502a, 502b, 502c, 502d, 502e, and 502f, such that one or more other symbols may be allocated between the sequential pairs of DMRS symbols 502a and 502b. The group of DMRS symbols 502a, 502b, 502c, 502d, 502e, and 502f includes multiple sequential pairs of DMRS symbols. The sequential pairs of DMRS symbols may also be referred to as neighboring pairs of DMRS symbols.

As shown in the example of FIG. 5A, a tone offset Δ(n) may offset tones between adjacent DMRS symbols of the group of DMRS symbols 502a, 502b, 502c, 502d, 502e, and 502f. The tone offset Δ(n) may be associated with a modulo operation. Based on the offset, DMRS tones 506 in one DMRS symbol are associated with a different carrier frequency (e.g., subcarrier) in comparison to DMRS tones 506 in an adjacent DMRS symbol. For example, the DMRS tones in a first DMRS symbol 502a are associated with respective carrier frequencies that are different than the respective carrier frequencies associated with the DMRS tones 506 of a second DMRS symbol 502b. The tone offset Δ(n) (e.g., hopping pattern) for each DMRS symbol n is selected so that the DMRS tones cover as many carrier frequencies as possible within a time period (e.g., the long SLIV 500).

In the example of FIG. 5A, the tone offset Δ(n)=2n. Therefore, resource elements 504 of an n—the DMRS symbol occupied by a DMRS tone 506 shift by Δ(n)=2n mod 12. For example, the first DMRS symbol 502a may be considered the 0^{th} DMRS symbol, therefore, the resource elements 504 that are occupied by DMRS tones 506 are not shifted. Additionally, the second DMRS symbol 502b (e.g., 1^{st} DMRS symbol) may be associated with an offset Δ(1)=2 mod 12=2. Therefore, for the second DMRS symbol 502b, the resource elements 504 that are occupied by DMRS tones 506 shift by two resource elements in comparison to the first DMRS symbol 502a. Additionally, the third DMRS symbol may be associated with an offset Δ(2)=4 mod 12=4. Therefore, for the third DMRS symbol 502c, the resource elements 504 that are occupied by DMRS tones 506 shift by four resource elements in comparison to the first DMRS symbol 502a.

In the example of FIG. 5A, one or more other symbols, such as PDSCH symbols, may be allocated between adjacent DMRS symbols of the group of DMRS symbols 502a, 502b, 502c, 502d, 502e, and 502f.

In some examples, the offset Δ(n) (e.g., hopping pattern) may be defined per DMRS symbol in a SLIV allocation. In some such examples, a different offset may be applied to each symbol of a group of symbols or a subset of symbols of the group of symbols, such that all DMRS tones may be covered in a time span, such as the SLIV allocation. In some examples, the hopping pattern may be periodic with a period of N DMRS symbols. For example, in the example of FIG. 5A, the hopping pattern has a period of three DMRS symbols (e.g., DMRS configuration type-2 is three DMRS symbols). Specifically, as shown in the example of FIG. 5A, the offset Δ(n) hopping resets after the third DMRS symbol 502c. A periodic hopping pattern may be desirable in high Doppler scenarios due to difficulty for a UE to predict the same DMRS tone that is far away from a current DMRS symbol. For example, predicting the same DMRS tone from the 0th DMRS symbol to the 2nd DMRS symbol can be difficult due to the rapid changes in a channel.

In some examples, two or more of the group of DMRS symbols 502a, 502b, 502c, 502d, 502e, and 502f may be allocated in adjacent pairs. FIG. 5B is a block diagram illustrating an example of a DMRS hopping pattern, in accordance with various aspects of the present disclosure. In the example of FIG. 5B, a long SLIV 500 may allocate PDSCH resources to a group of slots, irrespective of slot boundaries (the slot boundaries are not shown in the example of FIG. 5B). Various elements of the example of FIG. 5B are similar to the elements of FIG. 5A. For brevity, the description of elements that are similar to those in FIG. 5A will be omitted from the description of FIG. 5B. In the example of FIG. 5B, two adjacent DMRS symbols 502b-1 and 502b-2 may be paired together, such that no other symbol is allocated between the pair of adjacent DMRS symbols 502b-1 and 502b-2. In such examples, the offset Δ(n) may be the same for the pair of DMRS symbols 502b-1 and 502b-2 of the group of DMRS symbols 502a, 502b-1, 502b-2, 502c, 502d, 502e, and 502f. Specifically, because a time domain orthogonal cover code (TD-OCC) may differentiate between various ports, it may be desirable for pairs of DMRS tones corresponding to DMRS symbol pairs to be associated with the same carrier frequency. Assigning a same offset Δ(n) to pairs of DMRS symbols may reduce cross-port interference in frequency-selective channels. The group of DMRS symbols 502a, 502b-1, 502b-2, 502c, 502d, 502e, and 502f is not limited to only one pair of DMRS symbols 502b-1 and 502b-2, multiple pairs of DMRS symbols may be specified for the group of DMRS symbols 502a, 502b-1, 502b-2, 502c, 502d, 502e, and 502f.

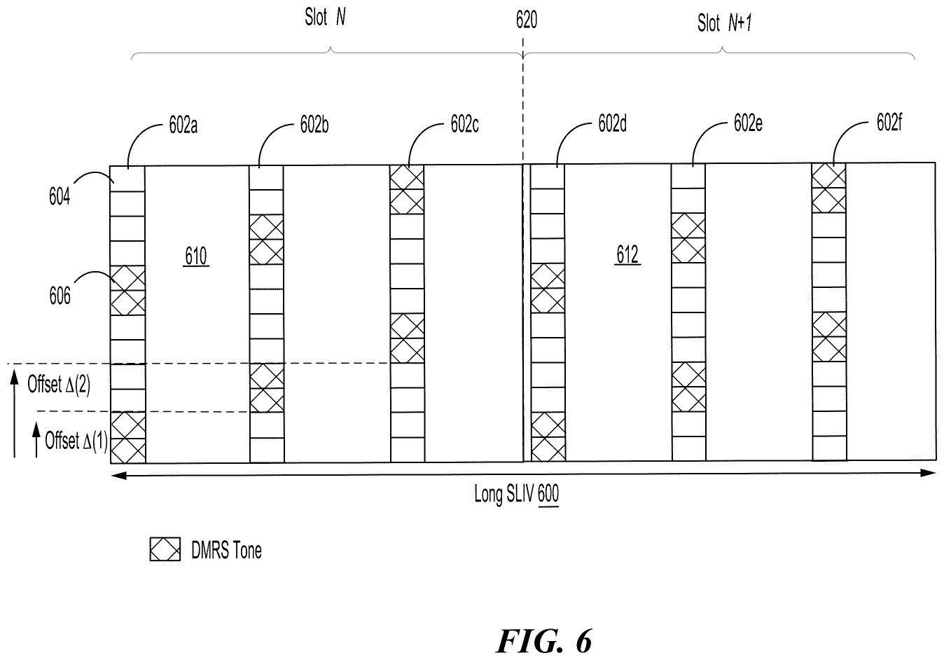

In some examples, to reduce implementation complexity for a UE, it may be desirable to maintain a same DMRS hopping pattern within one slot or mini-slot, or to avoid hopping entirely within that slot or mini-slot. This simplification helps the UE manage channel variations in high Doppler environments. In some examples, a hopping pattern may be defined per transmission time interval (TTI) (e.g., slot). FIG. 6 is a block diagram illustrating an example of a per TTI hopping pattern, in accordance with various aspects of the present disclosure. In the example of FIG. 6, a long SLIV 600 may allocate PDSCH resources to a group of slots 610 and 612 (shown as Slot N and Slot N+1), irrespective of slot boundaries. The long SLIV 600 is not limited to allocating the PDSCH to two slots 610 and 612. As an example, the long SLIV 600 allocates PDSCH resources to a first slot 610 (slot N) and a second slot 612 (slot N+1) irrespective of the slot boundary 620. In other examples, the long 600 allocates PUSCH resources to the first slot 610 and the second slot 612 (slot N+1) irrespective of the slot boundary 620.

Additionally, as shown in the example of FIG. 6, a group of DMRS symbols 602a, 602b, 602c, 602d, 602e, and 602f may be allocated (e.g., scheduled) with the long SLIV 600. Each DMRS symbol 602a, 602b, 602c, 602d, 602e, and 602f includes a group of resource elements 604. For ease of explanation, only one resource element 604 is labeled in the example of FIG. 6. Additionally, DMRS tones 606 (shown as cross-hatching) may be allocated to a subset of the group of resource elements 604 in each DMRS symbol 602a, 602b, 602c, 602d, 602e, and 602f. For ease of explanation only one DMRS tone 606 is labeled in the example of FIG. 6.

As shown in the example of FIG. 6, a first slot 610 may include a first set of DMRS symbols 602a, 602b, and 602c, and a second slot 612 may include a second set of DMRS symbols 602d, 602e, and 602f. Aspects of the present disclosure are not limited to each slot 610 and 612 having three DMRS symbols. Rather, each slot 610 and 612 may have two or more DMRS symbols. In the example of FIG. 6, the hopping pattern (e.g., offset Δ(n)) resets at initial DMRS symbols 602a and 602d of each slot 610 and 612. If each slot 610 and 612 has a sufficient quantity of DMRS symbols, then the hopping pattern may cycle through each carrier frequency with the respective DMRS tones 606 of each slot. If the slots 610 and 612 do not have a sufficient quantity of DMRS symbols to enable the respective DMRS tones 606 to cycle through each carrier frequency, then the offset Δ(n) between adjacent DMRS symbols may increase to cover a wider carrier frequency range. The example of FIG. 6 is an example of intra-slot hopping.

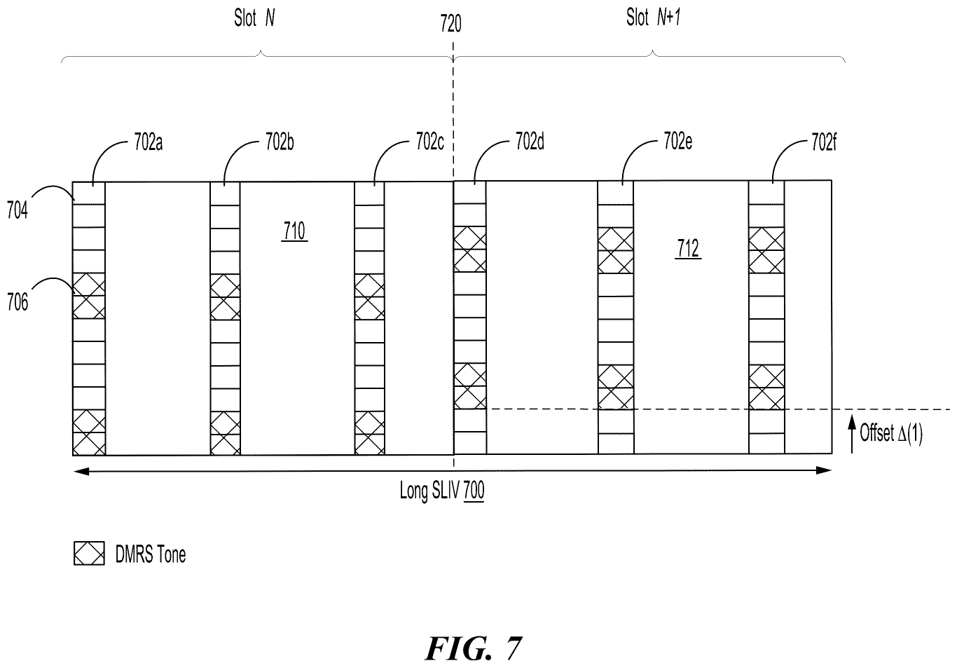

In other examples, the hopping pattern is defined across different TTIs (e.g., slots). FIG. 7 is a block diagram illustrating an example of defining a hopping pattern across different TTIs, in accordance with various aspects of the present disclosure. In the example of FIG. 6, a long SLIV 700 may allocate PDSCH resources to a group of slots 710 and 712 (shown as Slot n and Slot N+1) n, irrespective of slot boundaries. As an example, the long SLIV 700 allocates PDSCH resources to a first slot 710 (slot N) and a second slot 712 (slot N+1) irrespective of the slot boundary 720. In other examples, the long SLIV 700 allocates PUSCH resources to the first slot 710 and the second slot 712 (slot N+1) irrespective of the slot boundary 720.

Additionally, a group of DMRS symbols 702a, 702b, 702c, 702d, 702e, and 702f may be allocated (e.g., scheduled) with the long SLIV 700. Each DMRS symbol 702a, 702b, 702c, 702d, 702e, and 702f includes a group of resource elements 704. For case of explanation, only one resource element 704 is labeled in the example of FIG. 7. Additionally, DMRS tones 706 (shown as cross-hatching) may be allocated to a subset of the group of resource elements 704 in each DMRS symbol 702a, 702b, 702c, 702d, 702e, and 702f. For case of explanation, only one DMRS tone 706 is labeled in the example of FIG. 7.

As shown in the example of FIG. 7, a first slot 710 may include a first set of DMRS symbols 702a, 702b, and 702c, and a second slot 712 may include a second set of DMRS symbols 702d, 702e, and 702f. In the example of FIG. 7, the first set of DMRS symbols 702a, 702b, and 702c have the same offset, and the second set of DMRS symbols 702d, 702e, and 702f have the same offset, such that respective DMRS symbols within one TTI have the same offset. Different offsets may be applied across different TTIs. For example, the offset Δ(1) is applied to the second set of DMRS symbols 702d, 702e, and 702f. For ease of explanation, only one offset Δ(1) is shown in the example of FIG. 7. In the example of FIG. 7, the offset Δ(n) represents the tone offset for the n-th TTI, the first slot 710 being the 0^{th} TTI and the second slot 712 being the 1^{st} TTI. Applying different offsets to different TTIs may be desirable in low Doppler scenarios where multiple DMRS symbols are present within a slot, making cross-slot combining practical and effective. The example of FIG. 7 is an example of inter-slot hopping.

In some examples, the DMRS hopping pattern may be based on DMRS ports, with different DMRS ports mapping to distinct resource elements within a resource block. Additionally, different code division multiplexing (CDM) groups may occupy separate resource elements. For example, in a first DMRS symbol, DMRS tones may be transmitted over DMRS ports {0,1}, while in the second DMRS symbol, DMRS tones may be transmitted over DMRS ports {2,3}. This approach spreads DMRS tones across various carrier frequencies within a SLIV allocation, enhancing frequency diversity and reducing interference.

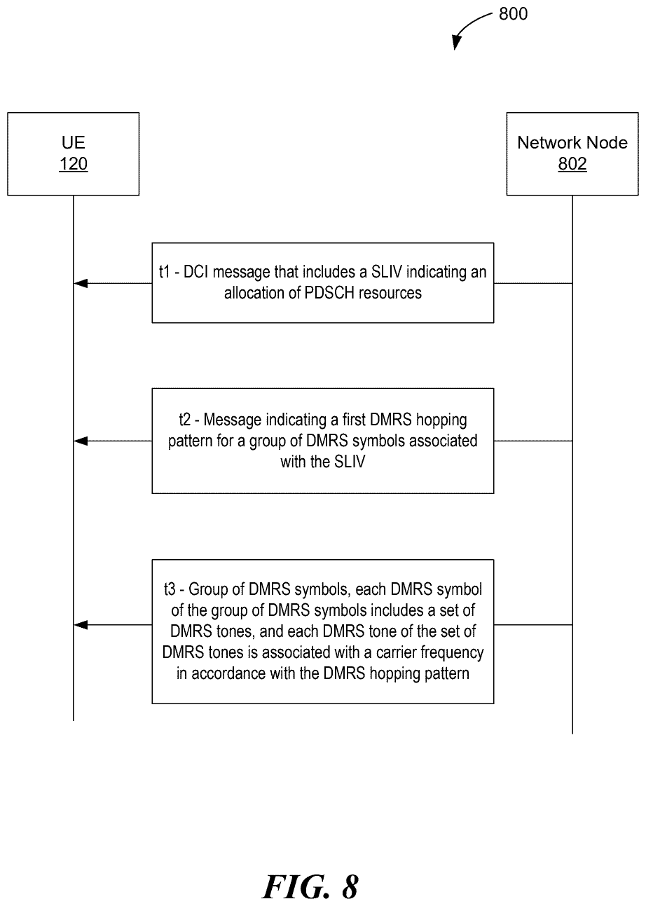

FIG. 8 is a timing diagram illustrating an example 800 of configuring a DMRS hopping pattern, in accordance with various aspects of the present disclosure. In the example 800, a UE 104 may communicate with a network node 802. The network node 802 may be an example of a network node 102 described with reference to FIGS. 1 and 2, a DU 330, an RU 380, or a CU 310 described with reference to FIG. 3. As shown in the example 800 of FIG. 4, at time t1, the network node 802 transmits, to the UE 104, a DCI message that includes a SLIV indicating an allocation of PDSCH resources. In some examples, the transmitting may include outputting, or sending (or outputting for transmission). For example, the network node 802 may output the DCI message for the UE 104. In some cases, rather than actually transmitting, for example, signals and/or data, the network node 802 may have an interface to output signals and/or data for transmission to the UE 104. In some such examples, the network node 802 may output, send, or output for transmission one or more signals to one or more other network entities, in which the one or more signals are intended for the UE 104. In some examples, the PDSCH resources are limited to a single slot. In other examples, the SLIV is a long SLIV, and the PDSCH resources are allocated to multiple slots, irrespective of slot boundaries.

At time t2, the network node 802 transmits, to the UE 104, a message indicating a first DMRS hopping pattern for a group of DMRS symbols associated with the SLIV. Alternatively, the network node 802 may output the message for the UE 104. The group of DMRS symbols may be allocated to one or more slots based on whether the SLIV allocates PDSCH resources to a single slot or multiple slots. In some examples, the message at time t2, or another message, configures a group of DMRS hopping patterns, in which the first DMRS hopping pattern is one of the group of DMRS hopping patterns. In such examples, another message may trigger one of the group of DMRS hopping patterns, or a single DMRS hopping pattern if only one DMRS hopping pattern is configured. That is, the UE 104 may receive signaling that enables or disables DMRS hopping. The DMRS hopping may be enabled or disabled based on whether a signal is being transmitted on a high delay spread channel. Additionally, in some examples, signaling may indicate a specific hopping pattern index from the group of hopping patterns. In some examples, the hopping patterns may be configured via higher layer signaling, and layer 1, layer 2, or layer 3 signaling may trigger a specific hopping pattern and/or enable or disable DMRS hopping. In some such examples, DMRS hopping (e.g., enabling or disabling DMRS hopping) or a specific DMRS hopping pattern index may be signaled via a DCI message, a MAC-CE message, or an RRC message. Additionally, or alternatively, a mode of hopping, such as per symbol (see FIG. 5A), intra-slot (see FIG. 6), inter-slot (see FIG. 7), or another type of hopping may be configured via RRC signaling.

As shown in the example 800, at time t3, the network node 802 may transmit the group of DMRS symbols. Alternatively, the network node 802 may output the group of DMRS symbols for the UE 104. Each DMRS symbol of the group of DMRS symbols includes a set of DMRS tones. Each DMRS tone of the set of DMRS tones is associated with a carrier frequency in accordance with the DMRS hopping pattern. Specifically, each one of the DMRS tones is associated with a respective resource element (RE) in a respective DMRS symbol in accordance with the DMRS hopping pattern. Each RE in a DMRS symbol is associated with a different carrier frequency (e.g., subcarrier). The UE 104 may estimate one or more channel characteristics based on the set of DMRS tones. In some examples, the UE 104 may transmit the estimated channel characteristics to the network node 802, and the network node 802 may adjust one or more communication parameters in accordance with the estimated channel characteristics.

The SLIV and the long SLIV are not limited to allocating PDSCH resources. In accordance with various aspects of the present disclosure, the SLIV or the long SLIV may allocate PUSCH resources. In such aspects, a DMRS hopping pattern may be specified for the PUSCH resources and the UE 104 may transmit a group of DMRS symbols, via the PUSCH resources, in accordance with the DMRS hopping pattern. Alternatively, the UE may output the group of DMRS symbols for the network node 802. In such cases, the network node 802 may obtain or receive the DMRS symbols. In some examples, rather than actually receiving signals and/or data, the network node 802 may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2. Additionally, the network node 802 may receive or obtain the DMRS symbols for another network entity, such as a higher tier network entity.

FIG. 9 is a flow diagram illustrating an example of a process 900 performed, for example, by a UE, in accordance with various aspects of the present disclosure. The UE is an example of a UE 104 described with reference to FIGS. 1, 2, 3, and 8. The example process 900 is an example of specifying a DMRS hopping pattern for a group of DMRS symbols allocated to each slot of one or more slots associated with a SLIV, such as a long SLIV. As shown in the example of FIG. 9, the process 900 begins at block 902 by receiving, from a network node, a first DCI message that includes a SLIV indicating an allocation of PDSCH resources. The SLIV may be a long SLIV. Additionally, the SLIV may allocate PUSCH resources instead of PDSCH resources. At block 904, the process 900 receives, from the network node, a first message indicating a DMRS hopping pattern for a group of DMRS symbols associated with the SLIV. At block 906, the process 900 receives, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

FIG. 10 is a flow diagram illustrating an example of a process 1000 performed, for example, by a UE, in accordance with various aspects of the present disclosure. The UE is an example of a UE 104 described with reference to FIGS. 1, 2, 3, and 8. The example process 1000 is an example of specifying a DMRS hopping pattern for a group of DMRS symbols allocated to each slot of one or more slots associated with a SLIV, such as a long SLIV. As shown in the example of FIG. 10, the process 1000 begins at block 1002 by receiving, from a network node, a first DCI message that includes a SLIV indicating an allocation of PUSCH resources. The SLIV may be a long SLIV. At block 1004, the process 1000 receives, from the network node, a first message indicating a DMRS hopping pattern for a group of DMRS symbols associated with the SLIV. At block 1006, the process 1000 transmits, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

FIG. 11 is a flow diagram illustrating an example process 1100 performed, for example, by a network node, in accordance with various aspects of the present disclosure. The network node is an example of a network node 102 described with reference to FIGS. 1 and 2, a DU 330, an RU 340, or a CU 310 described with reference to FIG. 3, or a network node 802 described with reference to FIG. 8. The example process 1100 is an example of specifying a DMRS hopping pattern for a group of DMRS symbols allocated to each slot of one or more slots associated with a SLIV, such as a long SLIV. As shown in the example of FIG. 10, the process 1100 begins at block 1102 by transmitting a first DCI message that includes a SLIV indicating an allocation of PDSCH resources. The SLIV may be a long SLIV. Additionally, the SLIV may allocate PUSCH resources instead of PDSCH resources. At block 1104, the process 1100 transmits a first message indicating a first DMRS hopping pattern for a group of DMRS symbols associated with the SLIV. At block 1106, the process 1100 transmits the group of DMRS symbols, each DMRS symbol of the group of DMRS symbols including one or more of DMRS tones, each DMRS tone of the one or more of DMRS tones associated with a carrier frequency in accordance with the first DMRS hopping pattern. In aspects where the SLIV allocates PUSCH resources, the network node may receive, from a UE, the group of DMRS symbols in accordance with the DMRS hopping pattern.

FIG. 12 is a flow diagram illustrating an example process 1200 performed, for example, by a network node, in accordance with various aspects of the present disclosure. The network node is an example of a network node 102 described with reference to FIGS. 1 and 2, a DU 330, an RU 340, or a CU 310 described with reference to FIG. 3, or a network node 802 described with reference to FIG. 8. The example process 1200 is an example of specifying a DMRS hopping pattern for a group of DMRS symbols allocated to each slot of one or more slots associated with a SLIV, such as a long SLIV. As shown in the example of FIG. 10, the process 1200 begins at block 1202 by transmitting a first DCI message that includes a SLIV indicating an allocation of PUSCH resources. The SLIV may be a long SLIV. At block 1204, the process 1200 transmits a first message indicating a first DMRS hopping pattern for a group of DMRS symbols associated with the SLIV. At block 1206, the process 1200 receives, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

Implementation examples are described in the following numbered clauses:
Clause 1. A method for wireless communication at a user equipment (UE), comprising: receiving, from a network node, a first downlink control information (DCI) message that includes a start and length indicator value (SLIV) indicating an allocation of physical downlink shared channel (PDSCH) resources; receiving, from the network node, a first message indicating a first demodulation reference signal (DMRS) hopping pattern for a group of DMRS symbols associated with the SLIV; and receiving, from the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 2. The method of Clause 1, respective DMRS tones associated with pairs of sequential DMRS symbols of the group of DMRS symbols are offset with respect to carrier frequency in accordance with the first DMRS hopping pattern; and one or more symbols are located between each pair of sequential DMRS symbols of the group of DMRS symbols.
Clause 3. The method of Clause 2, wherein: the group of DMRS symbols includes one or more pairs of adjacent DMRS symbols; respective sets of DMRS tones associated with each pair of adjacent DMRSs symbols are associated with a same carrier frequency; and each pair of adjacent DMRS symbols occupies adjacent symbols.
Clause 4. The method of any one of Clauses 1-3, wherein the first DMRS hopping pattern is periodic with a periodicity of a subset of DMRS symbols of the group of DMRS symbols.
Clause 5. The method of any one of Clauses 1-3, wherein the first DMRS hopping pattern is defined per transmission time interval (TTI) or across different TTIs.
Clause 6. The method of any one of Clauses 1-5, wherein: the SLIV is a long SLIV; the PDSCH resources are allocated to a group of slots; and the allocation of PDSCH resources is irrespective of slot boundaries of the group of slots.
Clause 7. The method of any one of Clauses 1-6, wherein the first message is a DCI message, media access control-control element (MAC-CE) message, or a radio resource control (RRC) message.
Clause 8. The method of any one of Clauses 1-7, further comprising estimating one or more channel characteristics in accordance with receiving the group of DMRS symbols.
Clause 9. The method of any one of Clauses 1-8, wherein the first DMRS hopping pattern is one of a group of DMRS hopping patterns.
Clause 10. The method of Clause 9, further comprising receiving a second message triggering one DMRS hopping pattern of the group of DMRS hopping patterns.
Clause 11. The method of any one of Clauses 1-10, further comprising: receiving, from a network node, a first DCI message that includes a SLIV indicating an allocation of physical uplink shared channel (PUSCH) resources; receiving, from the network node, a first message indicating a first DMRS hopping pattern for a group of DMRS symbols associated with the SLIV; and transmitting, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 12. A method for wireless communication at network node, comprising: transmitting a first DCI message that includes a SLIV indicating an allocation of PDSCH resources; transmitting a first message indicating a first DMRS hopping pattern for a group of DMRS symbols associated with the SLIV; and transmitting the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 13. The method of Clause 12, respective DMRS tones associated with pairs of sequential DMRS symbols of the group of DMRS symbols are offset with respect to carrier frequency in accordance with the first DMRS hopping pattern; and one or more symbols are located between each pair of sequential DMRS symbols of the group of DMRS symbols.
Clause 14. The method of Clause 13, wherein: the group of DMRS symbols includes one or more pairs of adjacent DMRS symbols; respective sets of DMRS tones associated with each pair of adjacent DMRSs symbols are associated with a same carrier frequency; and each pair of adjacent DMRS symbols occupies adjacent symbols.
Clause 15. The method of any one of Clauses 12-14, wherein the first DMRS hopping pattern is periodic with a periodicity of a subset of DMRS symbols of the group of DMRS symbols.
Clause 16. The method of any one of Clauses 12-14, wherein the first DMRS hopping pattern is defined per TTI or across different TTIs.
Clause 17. The method of any one of Clauses 12-16, wherein: the SLIV is a long SLIV; the PDSCH resources are allocated to a group of slots; and the allocation of PDSCH resources is irrespective of slot boundaries of the group of slots.
Clause 18. The method of any one of Clauses 12-17, wherein the first message is a DCI message, MAC-CE message, or an RRC message.
Clause 19. The method of any one of Clauses 12-18, further comprising receiving, from a user equipment (UE), a second message indicating one or more channel characteristics in accordance with transmitting the group of DMRS symbols.
Clause 20. The method of any one of Clauses 12-19, wherein the first DMRS hopping pattern is one of a group of DMRS hopping patterns.
Clause 21. The method of Clause 20, further comprising receiving a second message triggering one DMRS hopping pattern of the group of DMRS hopping patterns.
Clause 22. The method of any one of Clauses 12-22, further comprising: transmitting a first DCI message that includes a SLIV indicating an allocation of PDSCH resources; transmitting a first message indicating a first DMRS hopping pattern for a group of DMRS symbols associated with the SLIV; and receiving, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 23. A method for wireless communication at a network node, comprising: transmitting a first DCI message that includes a SLIV indicating an allocation of PUSCH resources; transmitting a first message indicating a first DMRS hopping pattern for a group of DMRS symbols associated with the SLIV; and receiving, from a UE, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 24. A method for wireless communication at a UE comprising: receiving, from a network node, a first DCI message that includes a SLIV indicating an allocation of physical uplink shared channel (PUSCH) resources; receiving, from the network node, a first message indicating a first DMRS hopping pattern for a group of DMRS symbols associated with the SLIV; and transmitting, to the network node, the group of DMRS symbols, each DMRS symbol of the group of DMRS symbols including one or more of DMRS tones, each DMRS tone of the one or more of DMRS tones associated with a carrier frequency in accordance with the first DMRS hopping pattern.
Clause 25. An apparatus comprising a processor, memory coupled with the processor, and instructions stored in the memory and operable, when executed by the processor to cause the apparatus to perform any one of Clauses 1-11 or 24.
Clause 26. An apparatus comprising at least one means for performing any one of Clauses 1-11 or 24.
Clause 27. A computer program comprising code for causing an apparatus to perform any one of Clauses 1-11 or 24.
Clause 28. A user equipment (UE), comprising: a processing system that includes processor circuitry and memory circuitry that stores code and is coupled with the processor circuitry, the processing system configured to cause the UE to perform any one of Clauses 1-11 or 24.
Clause 29. An apparatus comprising a processor, memory coupled with the processor, and instructions stored in the memory and operable, when executed by the processor to cause the apparatus to perform any one of Clauses 12-23.
Clause 30. An apparatus comprising at least one means for performing any one of Clauses 12-23.
Clause 31. A computer program comprising code for causing an apparatus to perform any one of Clauses 12-23.
Clause 32. A network entity, comprising: a processing system that includes processor circuitry and memory circuitry that stores code and is coupled with the processor circuitry, the processing system configured to cause the network entity to perform any one of Clauses 12-23.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication at a user equipment (UE), comprising:
one or more processors; and
one or more memories coupled with the one or more processors, the one or more processors configured to cause the UE to:
receive, from a network node, a first downlink control information (DCI) message that includes a start and length indicator value (SLIV), the SLIV indicates an allocation of physical downlink shared channel (PDSCH) resources;
receive, from the network node, a first message that indicates a first demodulation reference signal (DMRS) hopping pattern for a group of DMRS symbols associated with the SLIV; and
receive, from the network node, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

2. The apparatus of claim 1, wherein:
respective DMRS tones associated with pairs of sequential DMRS symbols of the group of DMRS symbols are offset with respect to carrier frequency in accordance with the first DMRS hopping pattern; and
one or more symbols are located between each pair of sequential DMRS symbols of the group of DMRS symbols.

3. The apparatus of claim 2, wherein:
the group of DMRS symbols includes one or more pairs of adjacent DMRS symbols;
respective sets of DMRS tones associated with each pair of adjacent DMRSs symbols are associated with a same carrier frequency; and
each pair of adjacent DMRS symbols occupies adjacent symbols.

4. The apparatus of claim 1, wherein the first DMRS hopping pattern is periodic with a periodicity of a subset of DMRS symbols of the group of DMRS symbols.

5. The apparatus of claim 1, wherein the first DMRS hopping pattern is defined per transmission time interval (TTI) or across different TTIs.

6. The apparatus of claim 1, wherein:
the SLIV is a long SLIV;
the PDSCH resources are allocated to a group of slots; and
the allocation of PDSCH resources is irrespective of slot boundaries of the group of slots.

7. The apparatus of claim 1, wherein the first message is a DCI message, media access control-control element (MAC-CE) message, or a radio resource control (RRC) message.

8. The apparatus of claim 1, wherein the one or more processors are further configured to cause the UE to estimate one or more channel characteristics in accordance with receiving the group of DMRS symbols.

9. The apparatus of claim 1, wherein the first DMRS hopping pattern is one of a group of DMRS hopping patterns.

10. The apparatus of claim 9, wherein the one or more processors are further configured to cause the UE to receive a second message triggering one DMRS hopping pattern of the group of DMRS hopping patterns.

11. An apparatus for wireless communication at a user equipment (UE), comprising:
one or more processors; and
one or more memories coupled with the one or more processors, the one or more processors configured to cause the UE to:
receive, from a network node, a first downlink control information (DCI) message that includes a start and length indicator value (SLIV), the SLIV indicates an allocation of physical uplink shared channel (PUSCH) resources;
receive, from the network node, a first message that indicates a first demodulation reference signal (DMRS) hopping pattern for a group of DMRS symbols associated with the SLIV; and
transmit, to the network node, the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

12. The apparatus of claim 11, wherein:
respective DMRS tones associated with pairs of sequential DMRS symbols of the group of DMRS symbols are offset with respect to carrier frequency in accordance with the first DMRS hopping pattern; and
one or more symbols are located between each pair of sequential DMRS symbols of the group of DMRS symbols.

13. The apparatus of claim 12, wherein:
the group of DMRS symbols includes one or more pairs of adjacent DMRS symbols;
respective sets of DMRS tones associated with each pair of adjacent DMRSs symbols are associated with a same carrier frequency; and
each pair of adjacent DMRS symbols occupies adjacent symbols.

14. The apparatus of claim 11, wherein the first DMRS hopping pattern is periodic with a periodicity of a subset of DMRS symbols of the group of DMRS symbols.

15. The apparatus of claim 11, wherein the first DMRS hopping pattern is defined per transmission time interval (TTI) or across different TTIs.

16. An apparatus for wireless communication at a network node, comprising:
one or more processors; and
one or more memories coupled with the one or more processors, the one or more processors configured to cause the network node to:
transmit a first downlink control information (DCI) message that includes a start and length indicator value (SLIV), the SLIV indicates an allocation of physical downlink shared channel (PDSCH) resources;
transmit a first message that indicates a first demodulation reference signal (DMRS) hopping pattern for a group of DMRS symbols associated with the SLIV; and
transmit the group of DMRS symbols, each DMRS symbol of the group of DMRS symbols includes one or more of DMRS tones, each DMRS tone of the one or more of DMRS tones associated with a carrier frequency in accordance with the first DMRS hopping pattern.

17. The apparatus of claim 16, wherein:
respective DMRS tones associated with pairs of sequential DMRS symbols of the group of DMRS symbols are offset with respect to carrier frequency in accordance with the first DMRS hopping pattern; and
one or more symbols are located between each pair of sequential DMRS symbols of the group of DMRS symbols.

18. The apparatus of claim 17, wherein:
the group of DMRS symbols includes one or more pairs of adjacent DMRS symbols;
respective sets of DMRS tones associated with each pair of adjacent DMRSs symbols are associated with a same carrier frequency; and
each pair of adjacent DMRS symbols occupies adjacent symbols.

19. The apparatus of claim 16, wherein the first DMRS hopping pattern is periodic with a periodicity of a subset of DMRS symbols of the group of DMRS symbols.

20. The apparatus of claim 16, wherein the first DMRS hopping pattern is defined per transmission time interval (TTI) or across different TTIs.

21. The apparatus of claim 16, wherein:
the SLIV is a long SLIV;
the PDSCH resources are allocated to a group of slots; and
the allocation of PDSCH resources is irrespective of slot boundaries of the group of slots.

22. The apparatus of claim 16, wherein the first message is a DCI message, media access control-control element (MAC-CE) message, or a radio resource control (RRC) message.

23. The apparatus of claim 16, wherein the one or more processors are further configured to cause the network node to receive, from a user equipment (UE), a second message that indicates one or more channel characteristics in accordance with transmission of the group of DMRS symbols.

24. The apparatus of claim 16, wherein the first DMRS hopping pattern is one of a group of DMRS hopping patterns.

25. The apparatus of claim 24, wherein the one or more processors are further configured to cause the network node to transmit a second message that triggers one DMRS hopping pattern of the group of DMRS hopping patterns.

26. An apparatus for wireless communication at a network node, comprising:
one or more processors; and
one or more memories coupled with the one or more processors, the one or more processors configured to cause the network node to:
transmit a first downlink control information (DCI) message that includes a start and length indicator value (SLIV) indicating an allocation of physical uplink shared channel (PUSCH) resources;
transmit a first message indicating a first demodulation reference signal (DMRS) hopping pattern for a group of DMRS symbols associated with the SLIV; and
receive the group of DMRS symbols, each DMRS symbol of the group of DMRS symbols including one or more of DMRS tones, each DMRS tone of the one or more of DMRS tones associated with a carrier frequency in accordance with the first DMRS hopping pattern.

27. The apparatus of claim 26, wherein:
respective DMRS tones associated with pairs of sequential DMRS symbols of the group of DMRS symbols are offset with respect to carrier frequency in accordance with the first DMRS hopping pattern; and
one or more symbols are located between each pair of sequential DMRS symbols of the group of DMRS symbols.

28. The apparatus of claim 27, wherein:
the group of DMRS symbols includes one or more pairs of adjacent DMRS symbols;
respective sets of DMRS tones associated with each pair of adjacent DMRSs symbols are associated with a same carrier frequency; and
each pair of adjacent DMRS symbols occupies adjacent symbols.

29. The apparatus of claim 26, wherein the first DMRS hopping pattern is periodic with a periodicity of a subset of DMRS symbols of the group of DMRS symbols.

30. The apparatus of claim 26, wherein the first DMRS hopping pattern is defined per transmission time interval (TTI) or across different TTIs.
